(19) United States
(12) Patent Application Publication
(10) Pub. No.: US 2015/0095819 A1
(43) Pub. Date: Apr. 2, 2015

(54) METHOD FOR DISPLAYING PREVIEWS IN A WIDGET

(71) Applicant: Samsung Electronics Co., Ltd., Gyeonggi-do (KR)

(72) Inventors: Duk-Ki HONG, Gyeonggi-do (KR); Hyuk KANG, Gyeonggi-do (KR); Sang-Hyup LEE, Gyeonggi-do (KR)

(21) Appl. No.: 14/476,854

(22) Filed: Sep. 4, 2014

(30) Foreign Application Priority Data
Sep. 30, 2013 (KR) 10-2013-0116618

(51) Int. Cl. G06F 3/0482; G06F 3/0484

(52) U.S. Cl. CPC G06F 3/0482; G06F 3/0484
USPC 715/765

(57) ABSTRACT

Provided is a method of displaying a widget, the method including: displaying a widget; displaying an application list of a plurality of applications within the widget; detecting a user selection on one of the plurality of applications; and displaying in the widget a preview screen of the selected application without executing the selected application.

### CROSS-REFERENCE TO RELATED APPLICATION

This application claims the priority under 35 U.S.C. §119(a) to Korean Application Serial No. 10-2013-0116618, which was filed in the Korean Intellectual Property Office on Sep. 30, 2013, the entire content of which is hereby incorporated by reference.

### TECHNICAL FIELD

The present disclosure relates to a widget of an application.

### BACKGROUND

Generally, portable phones have been widely utilized due to thier mobility. A portable phone supports various user functions in addition to mobile communication and a user operates the various functions using the portable phone.

The portable phone provides various applications. Recently, application widgets have been provided that enable a user to access contents provided in an application without executing the application, such as a clock, a calendar, a memo, search, a map, news, a real-time camera, and the like.

As noted above, application widgets have been provided that enable a user to access contents in an application without executing the application. A user may check, at a glance, information or a function provided by an application through a widget that functions as a preview of the information or the function without actually executing the application itself.

### SUMMARY

However, most widgets that provide such a preview are developed by an application provider in conjunction with or separately from the corresponding application. Therefore, a user may not have a preview widget for an application that is not accompanied with such a widget.

In view of the foregoing, embodiments of the present disclosure aim to partially resolve, alleviate, or remove the disadvantage noted above.

Accordingly, an aspect of the present disclosure is to provide a method of providing an application preview widget for applications not accompanied with such a widget.

In accordance with another aspect of the present disclosure, there is provided a method of displaying a widget, the method including: displaying a widget; displaying an application list of a plurality of applications within the widget; detecting a user selection on one of the plurality of applications within the widget; and displaying a preview screen of the selected application in the widget without executing the selected application.

In accordance with another aspect of the present disclosure, there is provided an electronic device, including a display unit to display a screen; and a controller to display a widget on the display unit; display an application list of a plurality of applications within the widget; detect a user selection on one of the plurality of applications; and display a preview screen of the selected application in the widget without executing the selected application.

In accordance with another aspect of the present disclosure, there is provided a method of displaying a widget, the method including: receiving a selection of one application from a list of selectable applications in the widget; and displaying a preview application screen corresponding to the selected application through the widget, wherein the widget includes an activity independent from an activity of the application.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 illustrates an example electronic device according to an embodiment of the present disclosure;

FIG. 2 illustrates example components of an application;

FIG. 3 is a flowchart illustrating an example method of displaying a widget according to an embodiment of the present disclosure;

FIG. 4A, FIG. 4B, FIG. 5A, FIG. 5B, FIG. 5C, FIG. 6A, FIG. 6B, FIG. 7A and FIG. 7B illustrate an example method of displaying a widget according to another embodiment of the present disclosure;

FIG. 8 is a flowchart illustrating an example method of displaying a widget according to another embodiment of the present disclosure; and

FIG. 9A and FIG. 9B illustrate an example of a method of displaying a widget by taking legibility into consideration.

### DETAILED DESCRIPTION

Various example embodiments will now be described more fully with reference to the accompanying drawings in which some example embodiments are shown. Therefore, it should be understood that there is no intent to limit example embodiments to the particular forms disclosed, but on the contrary, example embodiments are to cover all modifications, equivalents, and alternatives falling within the scope of the disclosure.

While terms including ordinal numbers, such as “first” and “second,” etc., may be used to describe various components, such components are not limited by the above terms. The terms are used merely for the purpose to distinguish an element from the other elements. For example, a first element could be termed a second element, and similarly, a second element could be also termed a first element without departing from the scope of the present disclosure. As used herein, the term “and/or” includes any and all combinations of one or more of the associated listed items.

The terms used in this application are for the purpose of describing particular embodiments only and are not intended to be limiting of the disclosure. As used herein, the singular forms are intended to include the plural forms as well, unless the context clearly indicates otherwise. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

Unless defined otherwise, all terms used herein have the same meaning as commonly understood by those of skill in the art. Such terms as those defined in a generally used dictionary are to be interpreted to have the meanings equal to the contextual meanings in the relevant field of art, and are not to be interpreted to have ideal or excessively formal meanings unless clearly defined in the present specification. Such terms as those defined in a generally used dictionary are to be interpreted to have the meanings equal to the contextual meanings in the relevant field of art, and are not to be interpreted to have ideal or excessively formal meanings unless clearly defined in the present specification.

In the present disclosure, an electronic device may refer to a terminal, a portable terminal, a mobile terminal, a communication terminal, a portable communication terminal, a portable mobile terminal, a display device, and/or the like.

For example, the electronic device may be a smart phone, a portable phone, a navigation device, a game console, a Television (TV), a notebook computer, a laptop computer, a Tablet computer, a Personal Media Player (PMP), a Personal Digital Assistants (PDA), and/or the like. The electronic device may be embodied as a pocket-sized portable communication terminal having a wireless communication function. Also, the electronic device may be a flexible device or a flexible display device.

The electronic device may communicate with an external electronic device such as a server and/or the like, or may execute an operation by interworking with an external electronic device. For example, the electronic device may transmit, to a server through a network, an image captured by a camera and/or positional information detected by a sensor unit. The network, although not limited thereto, may be a Local Area Network (LAN), a Wireless Local Area Network (WLAN), a Wide Area Network (WAN), Internet, a Small Area Network (SAN), and/or the like.

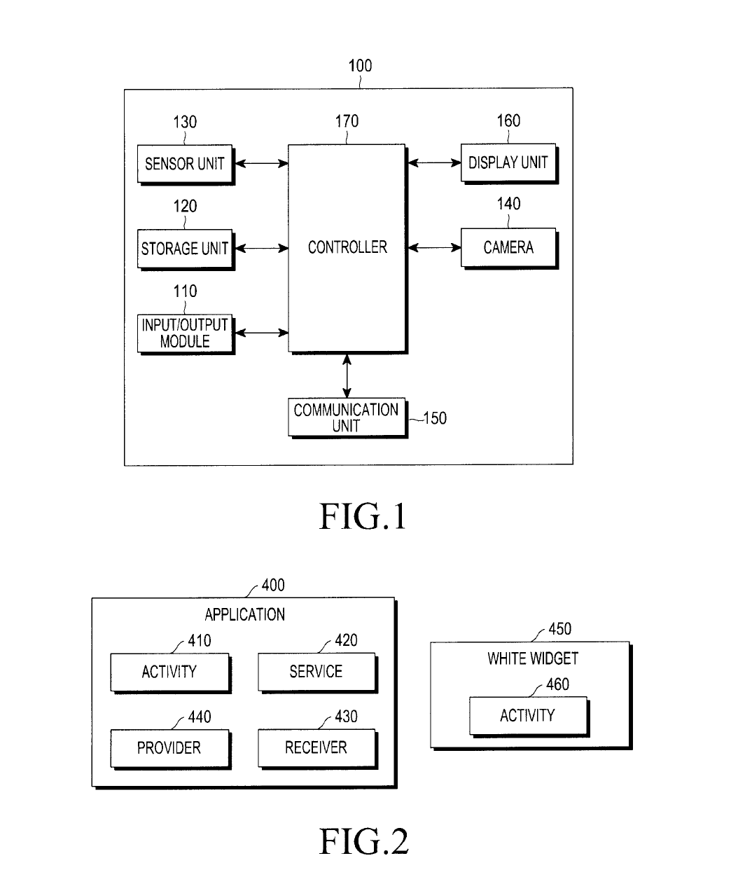

FIG. 1 illustrates an electronic device according to an embodiment of the present disclosure. FIG. 1 illustrates a representative configuration of an electronic device, and a few component elements may be omitted or modified as needed.

An electronic device 100 may include an input/output module 110, a storage unit 120, a sensor unit 130, a camera 140, a communication unit 150, a display unit 160, and a controller 170.

The input/output module 110, as a means to receive a user input or to inform a user of information, may include a plurality of buttons, a microphone, a speaker, a vibration motor, a connector, a keypad, a mouse, a trackball, a joystick, cursor direction keys, cursor control, and/or the like.

The button may be formed on a front side, a lateral side, and/or a back side, and may include a power/lock button, a volume button, a menu button, a home button, a back button, or a search button, and/or the like.

The microphone receives a voice or sound and generates an electrical signal according to a control of the controller 170.

The speaker may output sounds corresponding to various signals (for example, a wireless signal, a broadcasting signal, a digital audio file, a digital video file, capturing a picture, and/or the like) to the outside of the electronic device 100 according to a control of the controller 170.

The speaker may output a sound corresponding to a function that the electronic device 100 performs. One or a plurality of speakers may be formed on a proper position or positions of the electronic device 100.

The vibration motor may convert an electrical signal into a mechanical vibration according to a control of the controller 170. For example, when the electronic device 100 that is in a vibration mode receives a voice call from another electronic device (not illustrated), the vibration motor operates. One or a plurality of vibration motors may be formed in the electronic device 100. The vibration motor may operate in response to a user's touch motion that touches the display unit 160 and successive motions of a touch on the display unit 160.

A connector (not shown) may be used as an interface for connecting the electronic device 100 and a server, an external electronic device, or a power source. Based on a control of the controller 170, the connector may transmit data stored in the storage unit 120 of the electronic device 100 to an external device or may receive data from an external device through a cable wiredly connected to the connector. Through the cable wiredly connected to the connector, power may be input from a power source or a battery may be charged.

The keypad may receive a key input from a user for a control of the electronic device 100. The key pad may include a physical keypad formed in the electronic device 100, a virtual keypad display on the display unit 160, and/or the like.

The storage unit 120 may store data for driving one or a plurality of applications, such as a voice recognition application, a schedule management application, a word process application, a music application, an Internet application, a map application, a camera application, an e-mail application, an image editing application, a search application, a file search application, a video application, a game application, an SNS application, a phone application, a message application, and/or the like. The storage unit 120 may store images to provide a Graphical User Interface (GUI) related to one or a plurality of applications, databases or data such as user information, documents and/or the like, background images (a menu screen, an idle screen, and/or the like) or operating programs for operating the electronic device 100, and images captured by a camera, and/or the like. The storage unit 120 may be a non-transitory machine (for example, a computer)-readable medium, and a non-transitory machine-readable medium may be defined as a medium for providing data to the machine to perform a predetermined function. The non-transitory machine-readable medium may be a storage medium. The storage unit 120 may include a non-volatile medium, a volatile medium, and/or the like. All of these media should be a type that allows the commands transferred by the media to be detected by a physical instrument through which the machine reads the commands.

The non-transitory machine-readable medium may include, although not limited to, a floppy disk, a flexible disk, a hard disk, a magnetic tape, a Compact Disc Read-Only Memory (CD-ROM), an optical disk, a punch card, a paper tape, a RAM, a Programmable Read-Only Memory (PROM), an Erasable PROM (EPROM), a Flash-EPROM, and/or the like.

The sensor unit 130 may include one or a plurality of sensors that detects a state (a position, a point of compass, a movement, and/or the like) of the electronic device 100. For example, the sensor unit 130 may include a proximity sensor that detects whether a user approaches the electronic device 100, a motion/point of compass sensor that detects a motion of the electronic device 100 (for example, rotation, acceleration, deceleration, vibration and/or the like of the electronic device 100), and/or the like. Also, the motion/point of compass sensor may include an acceleration sensor (or a gravity sensor) that measures an inclination and detects a change in a linear velocity, a gyro sensor that detects an angular velocity, an impact sensor, a GPS sensor, a compass sensor (or a terrestrial magnetism sensor) that detects a point of compass, an inertial sensor that detects inertial force of a movement so as to provide various information associated with a mobile object which is a target of the measurement, such as an acceleration, a velocity, a direction, a distance, and/or the like. The sensor unit 130 may detect a state of the electronic device 100, may generate a signal corresponding to the detection so as to transmit the generated signal to the controller 170. For example, the GPS sensor may receive radio waves from a plurality of GPS satellites (not illustrated) in Earth orbit, and may calculate a GPS position of the electronic device 100 using a time of arrival of the radio waves from the GPS satellites (not illustrated) to the electronic device 100. The compass sensor may calculate a position or a point of compass of the electronic device 100.

The camera 140 may include a lens system that enables convergence of lights incident from the outside so as to form an optical image of a subject, an image sensor that converts an optical image into an electric image signal or data for outputting, and a driving unit that drives an image sensor based on a control of the controller 170, and may further include a flash and/or the like.

The communication unit 150 is provided for a direct connection or a connection through a network with a server or an external electronic device, and may be a wired or wireless communication unit. Also, the communication unit 150 may wiredly or wirelessly transmit data obtained from the controller 170, the storage unit 120, the camera 140, and/or the like or may wiredly or wirelessly receive data through an external communication line or the air so as to transfer the data to the controller 170 or to store the data in the storage unit 120.

The communication unit 150 may include a mobile communication module, a wireless LAN module, a short distance communication module, and/or the like. The communication unit 150, although not limited thereto, may include an integrated services digital network (ISDN) card, a modem, a Local Area Network (LAN) card, an infrared ray port, a Bluetooth port, a Zigbee port, a wireless port, and/or the like.

The mobile communication module may connect the electronic device 100 with an external device through mobile communication using one or a plurality of antennas based on a control of the controller 170. The mobile communication module transmits/receives a Radio Frequency (RF) signal for exchanging or uni-directionally transmitting or receiving data of a voice call, a video call, a Short Message Service (SMS), or a Multimedia Message Service (MMS) to/from a portable phone, a smart phone, a Tablet PC, or another device having a phone number or a network address input into the electronic device 100.

The wireless LAN module may be connected to the Internet according to a control of the controller 170 in a place where a wireless AP (Access Point) (not illustrated) is installed. The wireless LAN module supports the wireless LAN standard (IEEE802.11x) of the Institute of Electrical and Electronics Engineers (IEEE). The short distance communication module may wirelessly perform short distance communication between the electronic device 100 and an image forming apparatus (not illustrated) according to a control of the controller 170. The short distance communication scheme may include Bluetooth, Infrared Data Association (IrDA) and/or the like.

The display unit 160 displays an image or data input from the controller 170 on a screen. Examples of the display unit 160 may include a Liquid Crystal Display (LCD), a touch screen, and/or the like. The display unit 160 displays an image based on a control of the controller 170. When a user input means such as a finger, a stylus pen, and/or the like is in contact with a surface of the display unit 160, the display unit 160 generates a key contact interrupt, and outputs, to the controller 170, user input information including input coordinates and an input state based on a control of the controller 170.

The display unit 160 may provide GUIs that correspond to various services (for example, a phone call, data transmission, broadcasting and capturing of a picture/video), respectively, to a user. The display unit 160 may transmit, to the controller 170, user input information corresponding to one or a plurality of touches input to a GUI. The display unit 160 may receive an input of one or a plurality of touches through a body part (for example, a finger including a thumb) of a user or a touch input means (for example, a stylus pen). Also, the display unit 160 may receive an input of successive motions of a single touch from among one or a plurality of touches. The display unit 160 may transmit, to the controller 170, user input information corresponding to the successive motions of the input touch.

The touch may not be limited to a contact between the display unit 160 and a body part of a user or a touch input means, and may include a non-contact (for example, a detectable interval between a touch screen and a body part of a user or a touch input means is greater than 0 and less than or equal to 5 cm.). The detectable interval may become large based on the hovering sensing capability (e.g., detecting capability) of the display unit 160. The display unit 160 may be a touch screen, and the touch screen corresponds to, for example, a resistive type, a capacitive type, an infrared type, an acoustic wave type, an Electro Magnetic (EM) type, an Electromagnetic Resonance (EMR) type, and/or the like.

The controller 170 executes an application based on user input information, and the application executes a program operation based on the user input information. In this example, the user input includes an input through the input/output module 110, the display unit 160, the sensor unit 130, and/or the like, or an input through the camera 140. The controller 170 may include a bus for information communication, and a processor connected with the bus for information processing. The controller 170 may include a Central Processing Unit (CPU), an Application Processor (AP), and/or the like.

The controller 170 may further include a Random Access Memory (RAM) connected to the bus for temporarily storing information required by the processor, a Read Only Memory (ROM) connected to the bus for storing static information required by the processor, and/or the like.

The controller 170 controls general operations of the electronic device 100, and executes a method of displaying a widget according to the present disclosure.

In one example, an application may be a preload application, such as an SMS, a contact, a launcher, a browser, and/or the like, or a 3rd party application that is installed by being downloaded from the outside such as an online game and/or the like, and an application screen may be a screen shown when the application is executed. A preview screen may be a preview of the aplication screen shown when the application is executed. A widget may not display a prevew screen at an initial stage. In one example, when a user selects an application to be displayed in the widget, the widget may display a preview screen of the selected application (that is, a preview of the application screen). The widget may be automatically displayed on a home screen, although the user may not execute the widget. For example, a framework in an Android operating system may execute a boot process when the electronic device 100 is powered on, and the frame work may broadcast a boot complete message or event to the widget when the boot process is completed. The widget that receives the boot complete message may display the preview screen of the selected application on the home screen. The widget may provide at least a portion of information or at least a few of functions provided by the selected application. The widget may be used as a preview that displays, at a glance, information or a function provided by the selected application. When providing a general widget, a user may not select an application to be displayed on the widget. The widget which does not display a preview screen of an application may be referred to a white widget.

FIG. 2 illustrates components of an application. Various components of an application 400 may include an activity 410, a service component 420, a receiver 430, and a provider 440.

In one example, the activity 410 may be defined as a screen (that is, an application screen that is shown when an application is executed) including a user interface. A single activity may indicate a single screen, and an application that is displayed in a plurality of screens may include a plurality of activities. For example, a message application may include an activity of displaying a list of received messages or a list of sent messages, and an activity of displaying detailed contents of a message.

The service component 420 may be executed in a background, and may not provide a separate user interface. For example, the service component may perform an operation of playing back music, an operation of continuously exchanging messages with an external device through a network, and/or the like.

The receiver 430 may respond with respect to a notification of an operating system, or may transmit a notification. For example, when a notification such as “the screen being turned off” and/or the like is received from the operating system, the receiver 430 may perform an operation associated therewith, and when an operation of an application affects another application, may notify of the same.

The provider 440 may enable application 400 to access a database such as SQLite or the like.

A widget 450 may be a separate application from application 400, which includes activity 460 independent from activity 410 of application 400. Activity 460 of the widget 450 may have a unique life cycle (that is, a series of processes from creation to termination). The widget may be regarded as a container that may wrap an activity. The widget 450 may be executed even if the widget 450 includes only activity 410. The widget 450 may select an application and may display a preview application screen (that is, activity 460) that corresponds to the selected application. The widget 450 may further include a service, a receiver, and a provider, in addition to activity 410.

Example source code for defining a widget in AndroidManifest.xml of an Android operating system is shown below:

TABLE 1

<appwidget-provider

xmlns:android=“http://schemas.android.com/apk/res/android”

android:minWidth=“40dp”
android:minHeight=“40dp”
android:updatePeriodMillis=“86400000”
android:previewImage=“@drawable/preview”
android:initialLayout=“@layout/example_appwidget”

android:configure=“com.example.android.ExampleAppWidgetConfigure”

android:resizeMode=“horizontal|vertical”
android:widgetCategory=“home_screen|keyguard”
android:initialKeyguardLayout=“@layout/example_keyguard”>

</appwidget-provider>

minWidth, minHeight indicate a size of a widget, updatePeriodMillis indicates an interval of executing onUpdate( ) for updating an activity, initialLayout indicates a layout of a widget, configure designates an activity, resizeMode indicates a resizing mode and may select one of “horizontal”, “vertical”, and “none”, widgetCategory indicates a screen on which a widget is to be displayed and may select one of “home_screen” corresponding to a home screen and “keyguard” corresponding to a lock screen, and initialKeyguardLayout designates an initial layout of a widget in a lock screen.

As set in android:updatePeriodMillis=“86400000”, a periodic update time may be set for an activity of a widget. A destruction/creation process may be executed when an activity of a widget is updated based on an activity life cycle and, thus, an activity for which a separate onUpdate( )method is not specified may be updated.

For an activity of a widget, one example allows minimum size setting and resizing. Based on a change in legibility caused by resizing, an entire activity (that is, an entire preview screen) or a portion of the activity may be displayed on the widget. In one example, when a horizontal and/or vertical size of a window of the widget is greater than or equal to approximately 50% of a maximum horizontal and/or vertical size of the window for displaying a preview screen, the controller 170 may perform scaling of the preview screen. That is, the controller 170 may reduce the preview screen so that an entirety of the preview screen is displayed within the widget. In a further example, when the horizontal and/or vertical size of the window of the widget is less than approximately 50% of the maximum horizontal and/or vertical size of the window for discplaying the preview screen, the controller 170 may display a portion of the application's preview screen, as is the case when zooming in on a screen.

Below is example source code that illustrates the operation performed when an object in a widget is selected. The example source code also illustrates the operation performed when updating a widget.

TABLE 2

public class ExampleAppWidgetProvider extends
AppWidgetProvider {

public void onUpdate(Context context, AppWidgetManager

appWidgetManager, int[ ] appWidgetIds) {

final int N = appWidgetIds.length;
for (int i=0; i<N; i++) {

int appWidgetId = appWidgetIds[i];
Intent intent = new Intent(context,
ExampleActivity.class);

PendingIntent pendingIntent =

PendingIntent.getActivity(context, 0, intent, 0);

```
  RemoteViews views = new
  RemoteViews(context.getPackageName( ),
```

R.layout.appwidget_provider_layout);

```
  views.setOnClickPendingIntent(R.id.button,
  pendingIntent);
  appWidgetManager.updateAppWidget(appWidgetId,
  views);
}
```

}

}

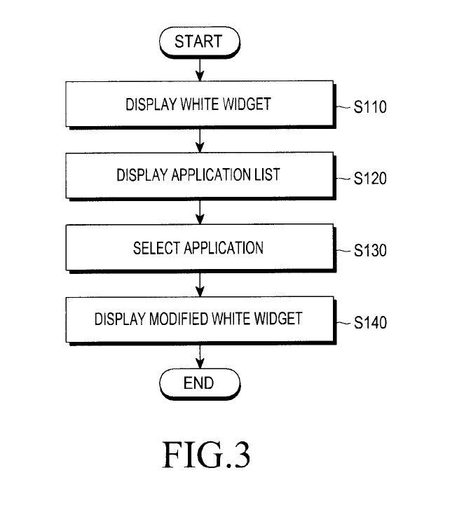

FIG. 3 is a flowchart illustrating a method of displaying a widget according to an embodiment of the present disclosure.

The method includes steps S110 through S140.

Step S110 corresponds to a step of displaying a widget, in which the controller 170 displays a widget on the display unit 160.

The controller 170 may display the widget on a default position in a default size based on widget settings initially stored in the storage unit 120, and may detect a user selection and input for resizing the widget. The user may resize a window of the widget through a drag touch gesture, selection of a menu, and/or the like. A home screen may be formed of a plurality of pages, and the user may scroll to the left or right through the home screen or may select a page button displayed on the home screen so as to move to a desired page of the home screen. The controller 170 may detect a user selection and input for adjusting a position of the widget. For example, the user selects a widget, and may select a page from among pages of the home screen and a position of the widget within the page, through dragging the widget and/or the like. As another example, the user may select a widget with a finger, and may select a page on which the widget is to be displayed through a multi-touch gesture that scrolls pages of the home screen with another finger.

Step S120 corresponds to a step of displaying an application list, in which the controller 170 displays, on the display unit 160, an allocation list of a plurality of applications that may be selectable by the user. The application list may include icons corresponding to the plurality of applications.

Step S130 corresponds to a step of selecting an application, in which the controller 170 detects a user selection on an application.

Step S140 corresponds to a step of displaying a modified widget, in which the controller 170 displays a widget that provides a preview of the application screen on the display unit 160 without executing the selected application. The preview application screen displayed on display unit 160 via the widget may be identical to the application screen shown when the user actually executes the application. The widget may display a preview of the application screen that would be shown first, when the user actually executes the application. The controller 170 may detect a user selection of an application screen on the widget. For example, the user may select a desired application screen preview through scrolling through the previews, selecting an object, and/or the like. Also, the user may select a desired portion or object from the entire preview of the application screen through scrolling, resizing the window of the widget, and/or the like. The user may resize the window of the widget using a drag gesture, selection of a menu, and/or the like. For example, the user may select a widget, and may select a position of a page from among pages of the home screen, on which the widget is to be displayed, through dragging the widget, and/or the like. The object selected by the user may be an item that would be displayed on display unit 160 of electronic device 100, if the application were executed. The object may be an image or text, for example, a window, a menu, a function item (or a menu item), a document, a picture, a video, an e-mail, an SMS message, an MMS message, and/or the like. The object may be selected, executed, deleted, cancelled, stored, or changed by user input. The object may be used as a meaning that includes a button, a short-cut icon, thumbnail image, or a folder that stores one or a plurality of objects in the electronic device 100.

The controller 170 may store settings of the widget in the storage unit 120. The settings of the widget may be applied when the widget is terminated and executed again. The settings of the widget may include a plurality of properties of the widget, and the plurality of properties may include identification information of an application to be displayed on the widget, a size of a window of the widget, a size of a font of the text in the widget, a position of the widget, information associated with a portion or the entirety of an application screen to be displayed on the widget, and/or the like. The information associated with a portion or the entirety of the preview application screen to be displayed on the widget may include mActivityURL that stores a URL of the application screen, mActivityRect that stores a display area of the application screen, and/or the like.

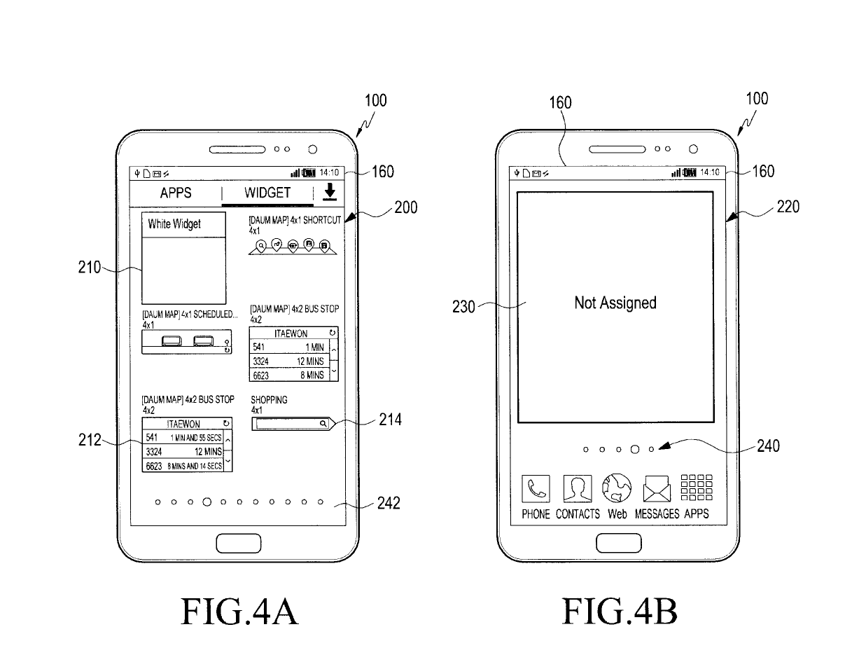

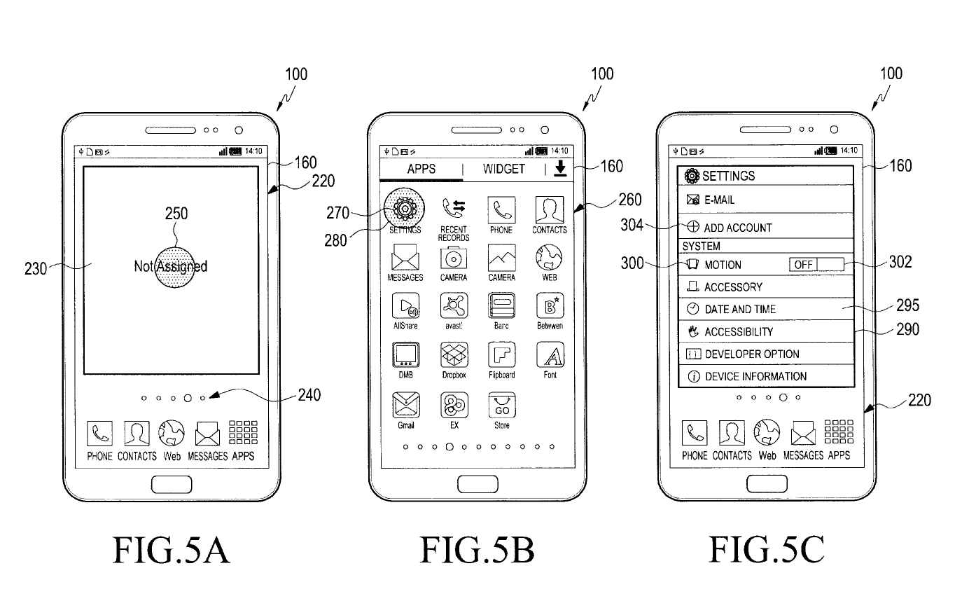

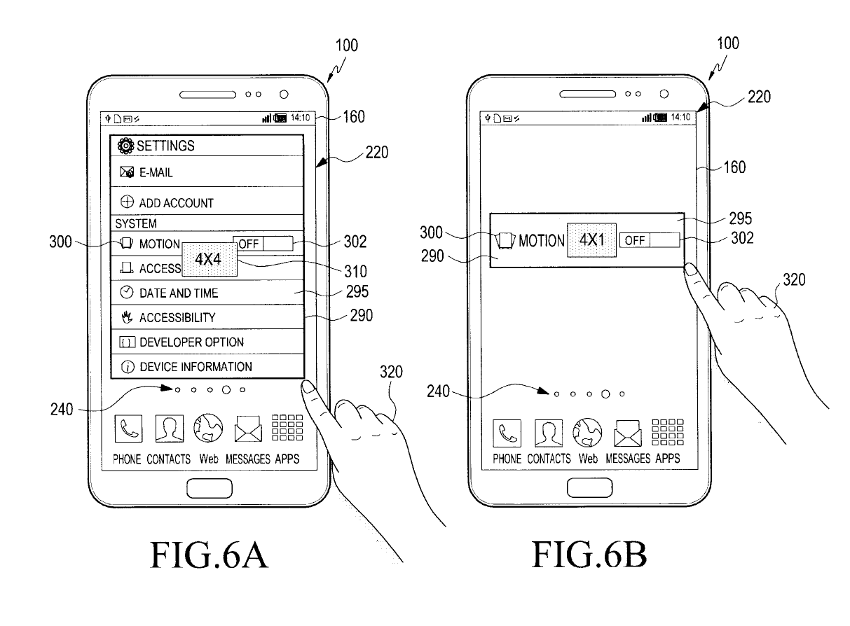

FIGS. 4 through 7 illustrate a method of displaying a widget according to another embodiment of the present disclosure.

Referring to FIG. 4A, the controller 170 displays a widget panel screen 200 on the display unit 160, and the widget panel screen 200 may display a plurality of widgets 210 and 212 (that is, a list of widgets) that are displayable on the home screen. The plurality of widgets include a widget 210 to provide previews of desired applications as described above. The plurality of widgets also include widget 212 that provides traffic information such as a number of a bus that will arrive at a bus stop closest to a current location, a scheduled arrival time, and/or the like, and the widget 214 that provides a search function associated with a predetermined online market, and/or the like.

Referring to FIG. 4B, the controller 170 may detect a user selection on a widget, and displays a widget 230 selected by the user on a home screen 220. A page of the home screen on which the widget 230 is to be displayed may be selected by the user or may be set by default. In the present example, the widget 230 is displayed to transparently overlap home screen 220, and the widget 230 may display words, an identifier, and/or the like indicating that a preview application screen is not displayed.

Referring to FIG. 5A, the controller 170 may detect a user touch 250 on the widget 230.

Referring to FIG. 5B, in response to the user touch on the widget 230, the controller 170 may display, on the display unit 160, an application list 260 of a plurality of applications that are selectable by a user. Also, the controller 170 displays, on the display unit 160, the application list 260 of a plurality of applications that are displayable on the widget 230 and that are selectable by the user.

The application list 260 may include text, icons, and/or the like that are associated with each of the plurality of applications. The controller 170 may detect a user touch 280 on one of the plurality of applications. In the present embodiment, the user may select settings 270.

Referring to FIG. 5C, in response to a user touch on the settings, the controller 170 displays, on a widget 290, a settings screen 295 which is one of the applications that are displayable on a widget. The settings screen 295 includes a plurality of objects for setting various environments of the electronic device 100. For example, the plurality of objects may include a motion object 300 for activating (or turning on) or deactivating (or turning off) motion recognition, or for setting an environment of motion recognition, an account adding object 304 for selecting and adding an account to be used in the electronic device 100, such as a Google account, a Samsung account, an e-mail account, and/or the like. The environment of motion recognition may be defined by various functions, and may include a direct call function for setting or cancelling a direct call to a phone number of a screen when a user puts the electronic device 100 close to an ear of the user while the screen corresponds a contact, recent records, a message checking screen, and/or the like, a mute/pause function for setting or cancelling to stop a sound and/or vibration when the electronic device 100 is turned over while the electronic device 100 outputs a sound or vibrates in association with reception of a call, alarm, playback of media file, and/or the like.

The motion object 300 may include an on/off button 302 for activating/deactivating motion recognition. In the example of FIG. 5C, the motion recognition is currently deactivated.

Referring to FIG. 6A, the controller 170 detects a selection of a user 320 for size/position adjusting, and enters a size/position adjusting mode of a widget 290. For example, when the user 320 touches an edge of the widget 290 or when the user touches the widget 290 and drags up or down, the controller 170 may enter the size/position adjusting mode of the widget 290. When it is in the size/position adjusting mode of the widget 290, the controller 170 may display a currently set size 310 of a window of a widget. For example, the size 310 of the window of the widget may be displayed as “horizontal length (for example, 1 through 4)*vertical length (for example, 1 through 4). A maximum horizontal length and a maximum vertical length that may display the widget 290 may be set to 4, respectively. FIG. 6A illustrates that the size 310 of the widget 290 is 4*4, and FIG. 6B illustrates a size 312 of the widget 290 is 4*1.

Referring to FIG. 6B, the controller 170 detects a user input for resizing, and decreases or increases (that is, modifies) a size of the widget 290 based on the user input for size adjusting. In this example, when the user 320 touches and drags the widget 290, the controller 170 decreases the size of the widget 290. In a further example, as the widget is resized, the widget 290 displays only the motion object 300 of the settings screen. The user may display only a desired object by scrolling through the settings screen.

Referring to FIG. 7A, the user 320 may move the widget 290 to a desired page of the home screen 220. In this example, the user 320 moves the widget 290 from the 4th page of the home screen 220 as shown in the page button 240 of FIG. 6B to the first page of the home screen 220 as shown in the page button 240 of FIG. 7A. The widget 290 may be displayed on the home screen together with other widgets such as a schedule widget 330 and/or the like. For example, when the user 320 touches the home screen 220 after adjustment of the size/position of the widget 290 is complete, the controller 170 may cancel or exit from the size/position adjusting mode.

Referring to FIG. 7B, the controller 170 detects a user input on the motion object 300 in the widget 290, and executes a function associated with the user input or applies settings associated with the user input. In this example, the user 320 selects the on/off button 302 of the motion object 300 so as to activate motion recognition.

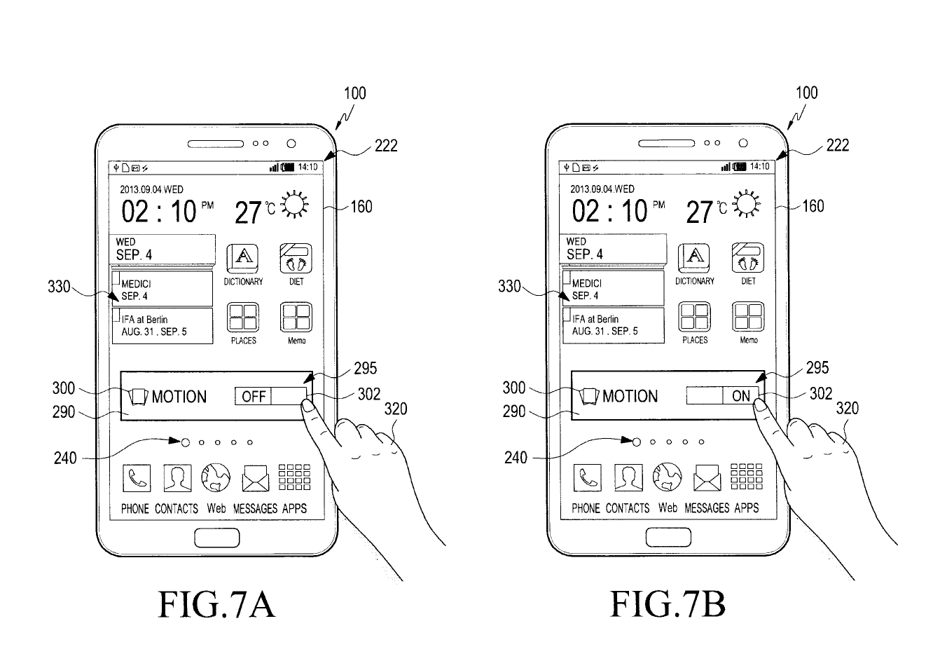

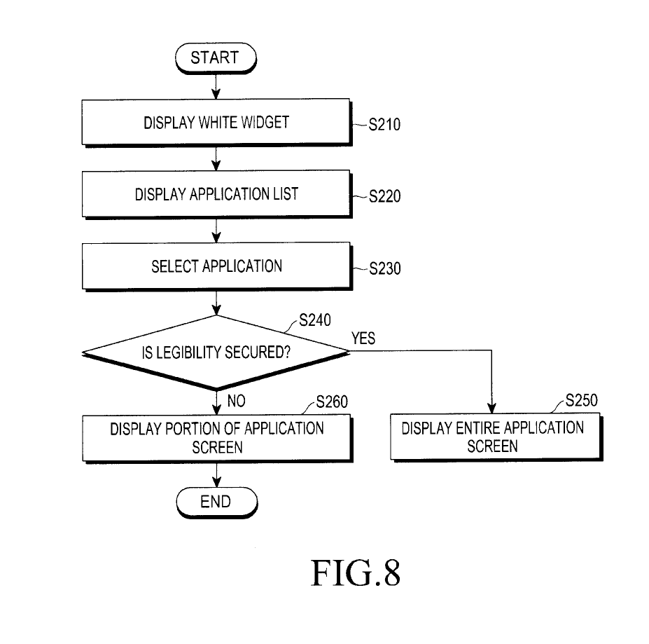

FIG. 8 is a flowchart illustrating a method of displaying a widget according to another embodiment of the present disclosure.

The method includes steps S210 through S260.

Step S210 corresponds to a step of displaying a widget, in which the controller 170 displays a widget on the display unit 160.

Step S220 corresponds to a step of displaying an application list, in which the controller 170 displays, on the display unit 160, an application list of a plurality of applications that are selectable by a user.

Step S230 corresponds to a step of selecting an application, in which the controller 170 detects a user selection on an application.

Step S240 corresponds to a step of determining securement of legibility, in which the controller 170 compares a property value of the widget with a threshold value. The property value of the widget may be a size of a window of the widget displayed as a window, a size of a font of text in the widget, and/or the like. When the horizontal and/or vertical size of the window of the widget is compared, the threshold value may be set to be approximately 50% of the entire screen horizontal and/or vertical size (or a maximum horizontal and/or vertical size in which an application screen may be displayed) of the display unit 160. When the size of the font of the text in the widget is compared, the threshold value may be set to be approximately 70% of the size of the font in the maximum size of the application screen. In one example, when the property value of the widget is greater than or equal to the threshold value, the controller 170 determines that the legibility is secured. In a further example, when the property value of the widget is less than the threshold value, the controller 170 determines that the legibility is not secured. The controller 170 executes step S250 when the legibility is secured, and executes step S260 when the legibility is not secured.

In step S250, the controller 170 displays an entirety of the preview screen of the application on the widget. For example, when the horizontal and/or vertical size of the window of the widget is greater than or equal to approximately 50% of the entire screen horizontal and/or vertical size (or the maximum horizontal and/or vertical size in which the application screen may be displayed) of the display unit 160, the entire preview screen is displayed on the widget.

In step S260, the controller 170 displays a portion of the preview screen on the widget. For example, when the horizontal and/or vertical size of the window of the widget is less than approximately 50% of the entire screen horizontal and/or vertical size (or the maximum horizontal and/or vertical size in which the application screen may be displayed) of the display unit 160, a portion of the preview screen is displayed on the widget.

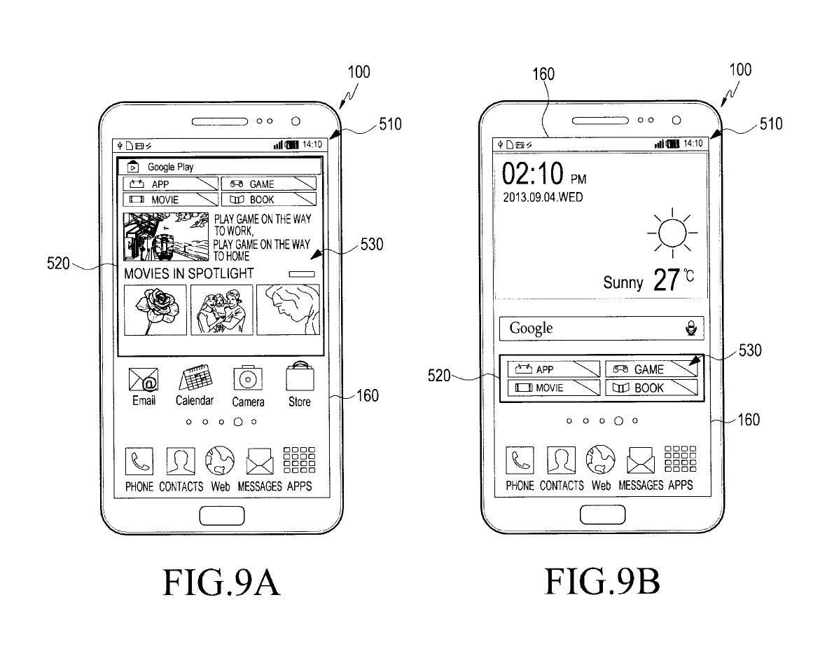

FIG. 9 illustrates an example of a method of displaying a widget by taking legibility into consideration.

Referring to FIG. 9A, the controller 170 determines that a size of a window of a widget 520 is greater than or equal to approximately 50% of a maximum size in which a preview screen 530 may be displayed, and displays the entirety of the preview screen 530 on the widget 520.

Referring to FIG. 9B, the controller 170 determines that the size of the window of the widget 520 is less than approximately 50% of the maximum size in which the preview screen 530 may be displayed, and displays a portion of the preview screen 530 on the widget 520.

Advantageously, examples disclosed in the present disclosure provide a widget to preview applications that are not accompanied by a preview widget. It may be appreciated that the embodiments of the present disclosure may be implemented in software, hardware, or a combination thereof. For example, each component element such as a storage unit, a communication unit, a controller, and/or the like in the electronic device of FIG. 1 may be configured as a device. Software may be stored, for example, in a volatile or non-volatile storage device such as a ROM, a memory such as a RAM, a memory chip, a memory device, or a memory IC, or a storage medium that is optically or magnetically recordable and simultaneously machine (for example, a computer)-readable, such as a CD, a DVD, a magnetic disk, or a magnetic tape, regardless of its ability to be erased or re-recorded. It is appreciated that the storage unit included in the electronic device is one example of a non-transitory machine-readable storage media suitable for storing a program or programs including commands for implementing various embodiments of the present disclosure. Therefore, embodiments of the present disclosure provide a program including codes for implementing a device or method claimed in any claim of the accompanying claims and a machine-readable device for storing such a program. Moreover, such a program as described above may be electronically transferred through an arbitrary medium such as a communication signal transferred through wired or wireless connection, and the present disclosure properly includes the equivalent thereof.

Further, the electronic device may receive the program from a program providing device connected to the electronic device wiredly or wirelessly and may store the received program. The program providing device may include a program including instructions to instruct the electronic device to perform a method of displaying a widget, a memory storing information required for the method of displaying a widget, a communication unit to perform wired or wireless communication with the electronic device, and a controller to transmit a corresponding program to the electronic device, automatically or in response to a request from the electronic device.

Although specific embodiments are described in the above description of the present disclosure, various modifications can be made without departing from the scope of the present disclosure. Accordingly, the scope of the present disclosure shall not be determined by the above-described embodiments, and is to be determined by the following claims and their equivalents.

What is claimed is:

1. A method of displaying a widget, the method comprising
executing a widget;
displaying an application list of a plurality of applications;
detecting a selection on one of the plurality of applications; and
displaying, within the widget, a preview screen of the selected application without executing the selected application.

2. The method of claim 1, further comprising:
displaying a widget list; and
detecting a selection of the widget from the widget list.

3. The method of claim 2, wherein the widget is displayed on a home screen including a plurality of pages.

4. The method of claim 3, further comprising:
detecting a selection of a page where the widget is to be displayed from among the pages of the home screen.

5. The method of claim 1, further comprising:
detecting an input corresponding to resizing of the widget; and
changing a size of a window of the widget based on the input.

6. The method of claim 5, wherein the input corresponds to a touch gesture.

7. The method of claim 1, further comprising:
detecting an input corresponding to resizing of the widget that displays the preview screen of the selected application; and
changing a size of a window of the widget that displays the preview screen of the selected application based on the input.

8. The method of claim 1, further comprising:
comparing a size of a window or a size of a font of the widget to a predetermined threshold value; and
determining a portion of the preview screen of the selected application to be displayed within the widget based on a comparison result.

9. The method of claim 8, wherein, when the size of the window or the size of the font of the widget is greater than or equal to the threshold value, an entirety of the preview screen of the application is displayed within the widget.

10. The method of claim 8, wherein, when the size of the window or the size of the font of the widget is less than the threshold value, only a portion of the preview screen of the application is displayed within the widget.

11. A non-transitory computer-readable medium which upon execution instructs at least one processor to:
execute a widget;
display an application list of a plurality of applications;
detect a selection on one of the plurality of applications; and
display, within the widget, a preview screen of the selected application without executing the selected application.

12. An electronic device, comprising:
a display unit to display a screen;
a controller to:
execute a widget on the display unit;
display an application list of a plurality of applications;
detect a selection on one of the plurality of applications; and
display, within the widget, a preview screen of the selected application without executing the selected application.

13. The electronic device of claim 12, further comprising:
a storage unit that stores settings of the widget,
wherein the settings of the widget include at least one of identification information of the selected application, a size of a window of the widget, a size of a font of text in the widget, a position of the widget, and information associated with a portion or an entirety of the preview screen of the selected application to be displayed within the widget.

14. The electronic device of claim 12, wherein the widget is displayed on a home screen including a plurality of pages.

15. The electronic device of claim 12, wherein the controller is configured to:
detect an input corresponding to resizing of the widget; and
change a size of a window of the widget based on the input.

16. The electronic device of claim 12, wherein the controller is configured to:
compare a size of a window or a size of a font within the widget to a predetemrined threshold value; and
determine a portion of the preview screen of the selected application to be displayed in the widget based on a comparison result.

17. The electronic device of claim 16, wherein, when the size of the window or the size of the font of the widget is greater than or equal to the threshold value, the controller is configured to display an entirety of the preview screen of the selected application within the widget.

18. The electronic device of claim 16, wherein, when the size of the window or the size of the font of the widget is less than the threshold value, the controller is configured to display only a portion of the preview screen of the application within the widget.

19. A method of displaying a widget, the method comprising:
receiving a selection of one application from a list of selectable applications; and
displaying in the widget a preview screen corresponding to the selected application,
wherein the widget includes an activity independent from an activity of the application.
